(19) United States
(12) Patent Application Publication
(10) Pub. No.: US 2001/0047043 A1
(43) Pub. Date: Nov. 29, 2001

(54) Method of preparing a polymerizate

(76) Inventors: Michael O. Okoroafor, Export, PA (US); Robert D. Herold, Monroeville, PA (US); Marvin J. Graham, Monroeville, PA (US); Robert A. Smith, Murrysville, PA (US); James R. Franks, Gibsonia, PA (US)

Correspondence Address: PPG INDUSTRIES INC, INTELLECTUAL PROPERTY DEPT, ONE PPG PLACE, PITTSBURGH, PA, 15272, US

(21) Appl. No.: 09/794,026

(22) Filed: Feb. 28, 2001

Related U.S. Application Data
(60) Provisional application No. 60/190,634, filed on Mar. 20, 2000.

(51) Int. Cl. C08G 75/08; C08J 3/28; G02F 1/07

(52) U.S. Cl. 522/31; 522/168; 522/162; 522/164; 522/165; 522/166; 522/146; 522/143; 359/241

(57) ABSTRACT

Describes polymerizing with actinic radiation a cationically polymerizable organic composition comprising (a) at least one polyfunctional thiirane having at least two groups represented by the following general formula I,

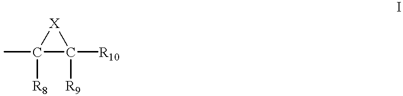

wherein X is selected from S and O, the number of functional groups wherein X is S constituting at least 50 percent of the total number of such functional groups present in said first polyfunctional thiirane, and R₈, R₉ and R₁₀ are each independently selected from hydrogen and C₁-C₁₀ alkyl; and (b) at least one actinic radiation activated cationic polymerization initiator.

This application claims the benefit of U.S. provisional application Serial No. 60/190,634, filed Mar. 20, 2000.

### DESCRIPTION OF THE INVENTION

The present invention relates to a method of preparing a polymerizate by exposing to actinic radiation a cationically polymerizable organic composition. More particularly, the cationically polymerizable organic composition of the present invention comprises (a) a polyfunctional thiirane having at least two functional groups selected from (i) epoxide, (ii) thiirane and (iii) combinations of (i) and (ii), provided that at least half of the functional groups of the polyfunctional thiirane are thiirane groups, and (b) an actinic radiation activated cationic polymerization initiator.

A number of polymeric materials, e.g., plastics, have been developed as alternatives and replacements for glass in applications such as, optical lenses, fiber optics, windows and automotive, nautical and aviation transparencies. As used herein, the term ‘glass’ is meant to refer to silica-based inorganic glass. These polymeric materials can provide advantages relative to glass, including, shatter resistance, lighter weight for a given application, ease of molding and ease of dying. Representative examples of such polymeric materials include, poly(methyl methacrylate), thermoplastic polycarbonate and poly[diethylene glycol bis(allylcarbonate)].

The refractive indices of many polymeric materials can be lower than that of glass For example, the refractive index of poly[diethylene glycol bis(allylcarbonate)] is about 1.50, whereas the refractive index of high index glass can range, for example, from 1.60 to 1.80. When fabricating lenses to correct a given visual defect, e.g., a correction for myopia, the use of a polymeric material having a lower refractive index will require a thicker lens relative to a material having a higher refractive index, e.g., high index glass. If the degree of correction required is substantial, e.g., in the case of severe myopia, a lens fabricated from a low index polymeric material can be so thick as to negate the benefit of reduction in weight obtained by use of a polymeric material. In addition, thick optical lenses are not aesthetically desirable.

It is known that polymeric materials having refractive indices greater than 1.50 can be prepared from monomers containing halogens and/or aromatic rings. However, many such higher index polymeric materials also have undesirably lower Abbe numbers (also known as nu-values). Lower Abbe numbers are indicative of an increasing level of chromatic dispersion, which is typically manifested as optical distortion at or near the rim of the lens.

More recently, polymeric materials, such as optical lenses, having a desirable combination of high refractive indices, e.g., 1.55 or higher, and high Abbe numbers, e.g., at least 27, have been prepared from the thermal polymerization of monomers having episulfide groups (also commonly referred to as thiirane groups). Polymeric materials prepared from the thermal curing of episulfide containing monomers are described in, for example, U.S. Pat. Nos. 5,945,504 and 5,807,975, and European Patent Application Nos. EP 874,016 A2, EP 928,802 A2 and EP 950,905 A2. These cited U.S. Patents and European Patent Applications do not describe actinic radiation initiated cationic polymerization of episulfide containing monomers.

U.S. Pat. Nos. 5,434,196 and 5,525,645 describe a resin composition for optical molding, which comprises an alicyclic epoxy resin having at least two epoxy groups, a vinyl ether resin having at least two vinyl groups, an actinic radiation-sensitive initiator for cationic polymerization, and optionally a thiirane compound. The thiirane compounds described in the '196 and '645 patents are monofunctional thiirane compounds. The resin compositions of the '196 and '645 patents are described as being suitable for preparing three-dimensional models without a mold by stacking laminar moldings, e.g., by means of stereolithography.

U.S. Pat. No. 5,981,616 describes a photocurable resin composition for the photo-fabrication of three-dimensional objects, which comprises an oxetane compound, an epoxy compound, a cationic photo-initiator, and optionally a thiirane. The thiiranes described in the '616 patent are monofunctional thiiranes.

U.S. Pat. No. 5,985,510 describes a stereolithographic process that makes use of an energy beam curable epoxy resin composition, which comprises a specific diepoxide, an energy beam sensitive cationic polymerization initiator, and optionally a thiirane compound. The thiirane compounds described in the '510 patent are monofunctional thiirane compounds.

In accordance with the present invention, there is provided a method of preparing a polymerizate by polymerizing a cationically polymerizable organic composition by exposing to actinic radiation said polymerizable composition, said polymerizable composition comprising:

(a) at least one first polyfunctional thiirane having at least two functional groups represented by the following general formula I,

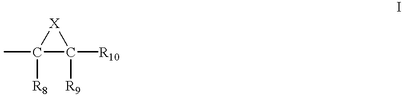

wherein X is selected from S and O, the number of functional groups wherein X is S constituting at least so percent of the total number of such functional groups present in said first polyfunctional thiirane, and R₈, R₉, and R₁₀ are each independently selected from hydrogen and C₁-C₁₀ alkyl (e.g., C₁-C₃ alkyl); and

(b) at least one actinic radiation activated cationic polymerization initiator.

Unless otherwise indicated, all numbers or expressions referring to quantities of ingredients, reaction conditions, etc. used herein are to be understood as modified in all instances by the term “about.”

### DETAILED DESCRIPTION OF THE INVENTION

The polymerizable composition of the method of the present invention comprises a polyfunctional thiirane having at least two groups represented by general formula I. In general formula I, C₁-C₁₀ alkyl groups from which R₈, R₉ and R₁₀ may each be independently selected include, methyl, ethyl, propyl (e.g., n-propyl and iso-propyl), butyl (e.g., n-butyl, sec-butyl and tert-butyl), pentyl, hexyl, heptyl, octyl, nonyl and decyl. Typically, alkyl groups from which each of R₈, R₉ and R₁₀ may be selected are C₁-C₃ alkyl, and more typically methyl and ethyl. In a preferred embodiment of the present invention, R₈, R₉ and R₁₀ are each hydrogen.

The first polyfunctional thiirane (a) of the polymerizable composition has at least two functional groups represented by general formula I, e.g., 2, 3, 4, 5, 6, 7, 8, 9 or 10 such groups. Typically, the first polyfunctional thiirane has 2 to 6 groups represented by general formula I, and more typically 2 to 4 groups such groups. When X is S, general formula I represents a thiirane group (also referred to as an episulfide or epithio group). When X is O, general formula I represents an epoxide group. The polyfunctional thiirane typically contains at least 50 percent of functional groups represented by general formula I wherein X is S, more typically at least 70 percent, preferably at least 90 percent, and more preferably 100 percent, based on the total number of functional groups of general formula I present in the first polyfunctional thiirane or mixture of first polyfunctional thiiranes.

The first polyfunctional thiirane (a) may have a back bone structure selected from a linear or branched aliphatic backbone structure, a cycloaliphatic backbone structure, a heterocyclic backbone structure, an aromatic backbone structure and combinations thereof. The backbone structure of the first polyfunctional thiirane may optionally contain linkages selected from oxide (ether) linkages (—O—); sulfide (thioether) linkages (—S—); disulfide linkages (—S—S—); sulfone linkages (—(O)S(O)—); ketone linkages (—C(O)—); ester linkages (—C(O)—O—); amino linkages (e.g., —NH— and —N(R′)— where R′ is an aliphatic, cycloaliphatic or aromatic group); amide linkages (—C(O)—NH— and —C(O)—N<); urethane linkages (—NH—C(O)—O—); thiourethane linkages (—NH—C(O)—S—); thiocarbamate linkages (—NH—C(S)—O—); dithiourethane linkages (—NH—C(S)—S—); urea linkages (—NH—C(O)—NH—); thiourea linkages (—NH—C(S)—NH—) and combinations thereof. Typically, the backbone structure of the first polyfunctional thiirane contains linkages selected from oxide linkages, sulfide linkages and combinations thereof.

Polyfunctional thiiranes that are useful in the present invention may be prepared by reacting the epoxide groups of a polyfunctional epoxide with a sulfurizing agent, e.g., thiocyanate, thiourea, triphenylphosphine sulfide or 3-methylbenzothiazole-2-thione, as is known to the skilled artisan. Typically, the sulfurizing agent used is either thiocycanate or thiourea. As the sulfurization reaction is not always 100 percent complete, some epoxide groups may not be converted to thiirane groups, and accordingly the resulting polyfunctional thiirane may contain some epoxide groups, as described previously herein with reference to X of general formula I.

Two common methods of polyfunctional thiirane synthesis involve the reaction of either epihalohydrin, e.g., epichlorohydrin, or 1-halo-2,3-propylene sulfide, with a reactant having at least one and preferably at least two active hydrogen groups. When an epihalohydrin is used, the resulting polyfunctional epoxide intermediate is converted to a polyfunctional thiirane by reaction with a sulfurizing agent, e.g., thiourea. When a 1-halo-2,3-propylene sulfide is used, e.g., 1-chloro-2,3-propylene sulfide, the polyfunctional thiirane is formed directly.

The material having at least one and preferably at least two active hydrogen groups, used to prepare polyfunctional thiiranes useful in the present invention, may have active hydrogen groups selected from hydroxyl, thiol, carboxylic acid, primary amine, secondary amine and combinations thereof. The material having at least one and preferably at least two active hydrogen groups may have a backbone structure selected from linear or branched aliphatic backbone structure, cycloaliphatic backbone structure, heterocyclic backbone structure, aromatic backbone structure and combinations thereof.

Materials having a single active hydrogen group that may be used in the preparation of polyfunctional thiiranes useful in the present invention typically also have at least one epoxide or thiirane group. Such materials having a single active hydrogen group include, for example, 1-hydroxy-2,3-propylene oxide, 1-thiol-2,3-propylene oxide, 1-hydroxy-2,3-propylene sulfide and 1-thiol-2,3-propylene sulfide.

Examples of polyols that may be used to prepare polyfunctional thiiranes useful in the present invention, include, but are not limited alkylene glycols, e.g., ethylene glycol and propylene glycol; di- through penta(alkylene glycols), e.g., di- through penta(ethylene glycol) and di- through penta(propylene glycol); poly(alkylene glycols) having more than 5 repeat units, e.g., poly(ethylene glycol); block copolymers of poly(alkylene glycols), e.g., poly[(ethylene glycol)-b-(propylene glycol)-b-(ethylene glycol)]; linear or branched alkyl polyols, e.g., 1,3-propane diol, 1,4-butane diol, 1,6-hexane diol, neopentyl glycol, glycerol, trimethylol propane, trimethylol ethane, pentaerythritol, di-trimethylol propane and di-pentaerythritol; cycloalkyl polyols, e.g., cyclohexane dimethanols, hydrogenated bisphenol A and alkylene oxide extended hydrogenated bisphenol A; aromatic polyols, e.g., dimethylol benzene, catechol, resorcinol, bisphenol A, bisphenol sulfone, bisphenol ether, bisphenol sulfide, 4,4′-dihydroxy-benzophenone and halogenated bisphenol A; and N,N-hydroxyalkylamides, e.g., N,N-2-hydroxyethylacetamide and bis(N,N-2-hydroxyethyl)adipamide. Polythiols that may be used to prepare polyfunctional thiiranes useful in the present invention, include, polythiols corresponding to those polyols as recited previously herein, e.g., 4,4′-dimercapto-benzophenone, and those polythiols as recited further herein. Examples of polyfunctional carboxylic acids that may be used to prepare polyfunctional thiiranes useful in the present invention, include, but are not limited to, linear or branched aliphatic polyfunctional carboxylic acids, e.g., adipic acid, sebacic acid and dodecanedioic acid; cycloaliphatic polyfunctional carboxylic acids, e.g., cyclohexane dicarboxylic acids and hexahydrophthalic acid; and aromatic polyfunctional carboxylic acids, e.g., terephthalic acid and phthalic acid.

Polyfunctional primary amines that may be used to prepare polyfunctional thiiranes useful in the present invention, include, but are not limited to, linear or branched aliphatic polyamines, e.g., alkylene diamines, such as 1,2-ethylene diamine and 1,3-diaminopropane; cycloaliphatic polyamines, e.g., bisaminocyclohexanes, bisaminomethylcyclohexanes and isophoronediamine; and aromatic polyamines, e.g., xylylenediamines, tolylenediamines and phenylenediamines. Examples of polyfunctional secondary amines that may be used to prepare polyfunctional thiiranes useful in the present invention, include, but are not limited to, N,N′-dialkyl-diaminoalkanes, e.g., N,N′-dimethylethylenediamine, N,N′-dimethyl-1,3-diaminopropane and N,N′-diethyl-1,3-diaminopropane. Examples of materials having both primary amines and secondary amines include, ethyleneamines, such as diethylenetriamine, triethylenetetramine, tetraethylenepentamine and pentaethylenehexamine.

Examples of polyfunctional thiiranes having linear or branched aliphatic substantially carbon skeleton backbone structure (i.e., the backbone being substantially free of those optional linkages as recited previously herein, e.g., oxide and sulfide linkages), from which the first polyfunctional thiirane may be selected, include, but are not limited to 1,1-bis(epithioethyl)methane, 1-(epithioethyl)-1-(β-epithiopropyl)-methane, 1,1-bis(β-epithiopropyl)methane, 1-(epithioethyl)-1-(β-epithiopropyl)-ethane, 1,2-bis(β-epithiopropyl)ethane, 1-(epithioethyl)-3-(β-epithiopropyl)butane, 1,3-bis(β-epithiopropyl)propane, 1-(epithioethyl)-4-(β-epithiopropyl)pentane, 1,4-bis(β-epithiopropyl)butane, 1-(epithioethyl)-5-(β-epithiopropyl)hexane, tetrakis(β-epithiopropyl)methane and 1,1,1-tris(β-epithiopropyl)propane.

Examples of polyfunctional thiiranes having cycloaliphatic substantially carbon skeleton backbone structure, from which the first polyfunctional thiirane may be selected, include, but are not limited to 1,3- and 1,4-bis(epithioethyl)cyclohexanes, 1,3- and 1,4-bis(β-epithiopropyl)cyclohexanes, bis[4-(epithioethyl)cyclohexyl]methane, bis[4-(β-epithiopropyl)cyclohexyl]methane, 2,2-bis[4-(epithioethyl)cyclohexyl]propane, 2,2-bis[4-(β-epithiopropyl)cyclohexyl]propane.

Polyfunctional thiiranes having aromatic substantially carbon skeleton backbone structure, from which the first polyfunctional thiirane may be selected, include, but are not limited to, 1,3- and 1,4-bis(epithioethyl)benzenes, 1,3- and 1,4-bis(β-epithiopropyl)benzenes, bis[4-(epithioethyl)phenyl]methane, bis[4-(β-epithiopropyl)phenyl]methane, 2,2-bis[4-(epithioethyl)phenyl]propane, 2,2-bis[4-(β-epithiopropyl)phenyl]propane, 4,4-bis(epithioethyl)biphenyls, and 4,4′-bis(β-epithiopropyl)biphenyls.

Polyfunctional thiiranes having linear or branched aliphatic backbone structure and oxide linkages that are useful in the present invention, include, but are not limited to bis(β-epithiopropyl)ether, bis(β-epithiopropyloxy)methane, 1,2-bis(β-epithiopropyloxy)ethane, 1,3-bis(β-epithiopropyloxy)propane, 1,2-bis(β-epithiopropyloxy)propane, 1-(β-epithiopropyloxy)-2-(β-epithiopropyloxymethyl)propane, 1,4-bis(β-epithiopropyloxy)butane, 1,5-bis(β-epithiopropyloxy)pentane, tetrakis(β-epithiopropyloxymethyl)methane and 1,1,1-tris(β-epithiopropyloxymethyl)propane.

Polyfunctional thiiranes having cycloaliphatic backbone structure and oxide linkages that are useful in the present invention, include, but are not limited to bis(β-epithiopropyloxy)cyclohexanes, bis(β-epithiopropyloxymethyl)cyclohexanes, bis[4-(β-epithiopropyloxy)cyclohexyl]methane, 2,2-bis[4-(β-epithiopropyloxy)cyclohexyl]propane and bis[4-(β-epithiopropyloxy)cyclohexyl]sulfide.

Examples of polyfunctional thiiranes having aromatic backbone structure and oxide linkages that are useful in the present invention, include, but are not limited to bis(β-epithiopropyloxy)benzenes, bis(β-epithiopropyloxymethyl)benzenes, bis[4-(1-epithiopropyloxy)phenyl]methane, 2,2-bis[4-(β-epithiopropyloxy)phenyl]propane, 4,4′-bis(β-epithiopropyloxy)biphenyl, bis[4-(β-epithiopropyloxy)phenyl]sulfide, bis[4-β-epithiopropyloxy)phenyl]sulfone and 4,4′-bis(β-epithiopropyloxy)benzophenone.

Polyfunctional thiiranes having linear or branched aliphatic backbone structure and sulfide linkages that are useful in the present invention, include, but are not limited to bis(β-epithiopropyl)sulfide, bis(β-epithiopropylthio)methane, 1,2-bis(β-epithiopropylthio)ethane, 1,3-bis(β-epithiopropylthio)propane, 1,2-bis(β-epithiopropylthio)propane, 1-(β-epithiopropylthio)-2-(β-epithiopropylthiomethyl)propane, 1,4-bis(β-epithiopropylthio)butane, 1,3-bis(β-epithiopropylthio)butane, 1,5-bis(β-epithiopropylthio)pentane, tetrakis(β-epithiopropylthiomethyl)methane and 1,1,1-tris(β-epithiopropylthiomethyl)propane. Further examples of polyfunctional thiiranes having linear or branched aliphatic backbone structure and sulfide linkages, that may be used in the present invention, are described in U.S. Pat. No. 5,807,975 at column 3, line 1 through column 7, line 50, which disclosure is incorporated herein by reference.

Polyfunctional thiiranes having cycloaliphatic backbone structure and sulfide linkages that are useful in the present invention, include, but are not limited to bis(β-epithiopropylthio)cyclohexanes, bis(β-epithiopropylthiomethyl)cyclohexanes, bis[4-(β-epithiopropylthio)cyclohexyl]methane, 2,2-bis[4-(β-epithiopropylthio)cyclohexyl]propane, bis [4-(β-epithiopropylthio)cyclohexyl]sulfide, bis[4-(β-epithiopropyl)-cyclohexyl]sulfide, and bis[4-(epithioethylcyclohexyl]sulfide. Examples of polyfunctional thiiranes having aromatic backbone structure and sulfide linkages that are useful in the present invention, include, but are not limited to bis(β-epithiopropylthio)benzenes, bis(β-epithiopropylthiomethyl)benzenes, bis[4-(β-epithiopropylthio)phenyl]methane, 2,2-bis[4-(β-epithiopropylthiopropylthio)phenyl]propane, bis[4-(β-epithiopropylthio)phenyl]sulfide, bis[4-(β-epithiopropylthio)phenyl]sulfone, 4,4′-bis(β-epithiopropylthio)biphenyl, bis[4-(epithioethyl)phenyl]sulfide, bis[4-(β-epithiopropyl)phenyl]sulfide and 4,4′-bis(β-epithiopropylthio)benzophenone. Polyfunctional thiiranes having aromatic backbone structure and sulphone linkages include, for example, bis[4-(epithioethyl)phenyl]sulfone and bis[4-(β-epithiopropyl)phenyl]sulfone.

Polyfunctional thiiranes useful in the present invention may have heterocyclic backbone structure containing, for example, oxygen, sulfur, nitrogen and/or silicon atoms. Heterocyclic backbone structures containing sulfur atoms are preferred. A preferred class of heterocyclic backbone structure is dithiane backbone structure, and in particular 1,4-dithiane backbone structure. Examples of polyfunctional thiiranes having 1,4-dithiane backbone structure that may be used in the present invention include, but are not limited to, 2,5-bis(epithioethyl)-1,4-dithane, 2,5-bis(β-epithiopropyl)-1,4-dithiane, 2,5-bis(β-epithiopropyloxymethyl)-1,4-dithiane, 2,5-bis(β-epithiopropyloxyethyloxymethyl)-1,4-dithiane, 2,5-bis(β-epithiopropylthiomethyl)-1,4-dithiane and 2,5-bis(β-epithiopropylthioethylthiomethyl)-1,4-dithiane. Additional examples of useful polyfunctional thiiranes having 1,4-dithiane backbone structure are described in U.S. Pat. No. 5,945,504 at column 3, line 40 through column 5, line 14, which disclosure is incorporated herein by reference.

Polyfunctional thiiranes having backbone linkages selected from urethane linkages, thiourethane linkages, thiocarbamate linkages, dithiourethane linkages, urea linkages, thiourea linkages and combinations thereof may be prepared according to methods that are known to those of ordinary skill in the art. Typically, an intermediate having active hydrogen group functionality is formed from the combination of (i) a first reactant having two or more active hydrogen groups selected from hydroxyl, thiol, primary amine, secondary amine and combinations thereof, and (ii) a second reactant having at least two functional groups selected from isocyanate (—NCO), isothiocyanate (—NCS) and combinations thereof. The equivalents ratio of the active hydrogen groups of the first reactant to the iso(thio)cyanate groups of the second reactant is selected such that the intermediate product of the combination is active hydrogen group functional, e.g., having hydroxyl or thiol functionality. The active hydrogen group functional intermediate may then be further reacted with an epihalohydrin to form a polyfunctional epoxide intermediate, which is then converted to a polyfunctional thiirane by reaction with a sulfurizing agent, as described previously herein. Alternatively the active hydrogen group functional intermediate may be reacted with a l-halo-2,3-ethylene sulfide to form a polyfunctional thiirane, as described previously herein In the preparation of polyfunctional thiiranes having backbone linkages selected from urethane linkages, thiourethane linkages, thiocarbamate linkages, dithiourethane linkages, urea linkages, thiourea linkages and combinations thereof, the first reactant having two or more active hydrogen groups selected from hydroxyl, thiol, primary amine, secondary amine and combinations thereof may be selected from those examples as recited previously herein. The second reactant having at least two functional groups selected from isocyanate, isothiocyanate and combinations thereof, may be selected from those that are known to the skilled artisan, e.g., toluene diisocyanate, isophorone diisocyanate, 1,2-diisothiocyanatoethane and 1-isocyanato-4-isothiocyanatocyclohexane. Examples of suitable poly(isocyanate), poly(isothiocyanate) and poly(isocyanate-isothiocyanate) reactants are described in U.S. Pat. No. 5,932,681 at column 5, line 60 through column 8, line 62, which disclosure is incorporated herein by reference.

In an embodiment of the present invention, R₈, R₉ and R₁₀ or general formula I are each hydrogen, and the first polyfunctional thiirane is selected from a novel polyfunctional thiirane represented by the following general formulas,

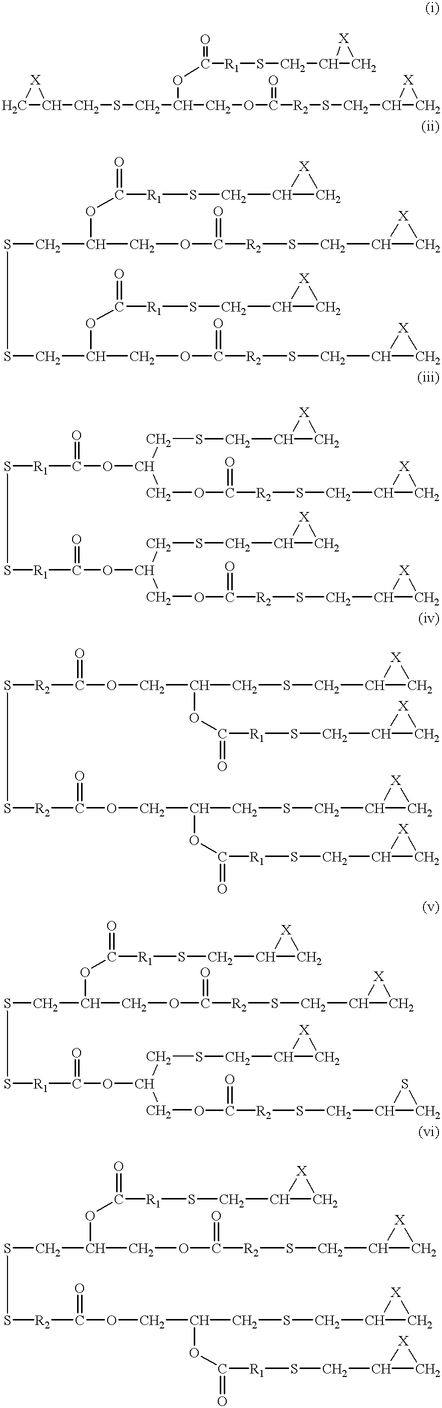

and mixtures of at least two of (i), (ii), (iii), (iv), (v), (vi), (vii), (viii), (ix), (x) and (xi);

wherein X is selected from S and O, the number of functional groups (i.e.

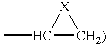

wherein X is S constituting at least 50 percent of the total number of such functional groups present in said polyfunctional thiirane; and R₁, R₂ and R₃ are each selected independently for each general formula from the group consisting of linear or branched chain alkylene (usually containing from 1 to 20 carbon atoms, e.g., 1 to 10 carbon atoms, preferably 1 to 4 carbon atoms and more preferably 1 to 2 carbon atoms), cyclic alkylene (usually containing from 5 to 8 carbon atoms), phenylene and C₁—C₉ alkyl substituted phenylene. Preferably, R₁, R₂ and R₃ are each selected independently for each of general formulas (i) through (xi) from C₁—C₂₀ linear or branched chain alkylene, and more preferably from methylene and ethylene.

Each of the polyfunctional thiiranes represented by general formulas (i) through (xi) may be prepared as described previously herein from a corresponding polythiol starting material. For example, the polythiol starting materials that are reacted with either an epihalohydrin or 1-halo-2,3-ethylene sulfide in the preparation of the polyfunctional thiiranes represented by general formulas (i) and (viii), may be represented by the following general formulas II and III respectively,

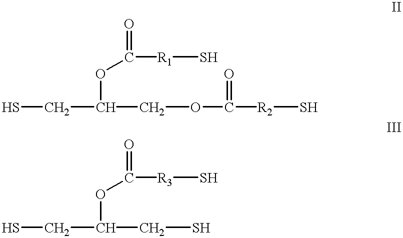

wherein R₁, R₂ and R₃ are as described previously herein.

The polythiol starting materials represented by general formulas II and III may be prepared by methods known in the art, for example, from an esterification or transesterification reaction between 3-mercapto-1,2-propanediol or 1,3-dimercapto-2-propanol respectively, and a thiol functional carboxylic acid or carboxylic acid ester in the presence of a strong acid catalyst, e.g., methane sulfonic acid, with the concurrent removal of water or alcohol from the reaction mixture. The preparation of polythiols represented by general formulas II and III is described in further detail in U.S. Pat. No. 5,973,192, the disclosure of which is incorporated herein by reference in its entirety. As used herein, the polythiols described and named with reference to general formulas II and III (e.g., thioglycerol bis(2-mercaptoacetate) and 1,3-dimercapto-2-propanol mercaptoacetate) is meant to include also any related co-product oligomeric species and polythiol monomer compositions containing residual starting materials.

The polythiol starting materials represented by general formulas II and III may each be separately subjected to an oxidative coupling reaction in the presence of a suitable oxidizing agent, such as a peroxide, to form dimers containing disulfide linkages. The polythiol starting material of general formula II may be subjected to an oxidative coupling reaction to form the polythiol starting materials for each of the polyfunctional thiiranes represented by general formulas (ii) through (vii). The polythiol starting materials corresponding to each of the polyfunctional thiiranes represented by general formulas (ix) through (xi) may be prepared by subjecting the polythiol starting material represented by general formula III to an oxidative coupling reaction.

Typically, when either of the polythiol starting materials represented by general formulas II or III are subjected to an oxidative coupling reaction, a mixture of uncoupled polythiol, polythiol dimers and polythiol oligomers results. The mixture may be resolved into separate polythiol starting materials by art recognized methods, or used as a mixture of polythiol starting materials from which a mixture of polyfunctional thiiranes may be prepared. In addition, preparation of the polythiol starting materials represented by general formulas II and III can itself result in the formation of coproduct polythiol dimers and oligomers. Accordingly, each of the polyfunctional thiiranes represented by general formulas (i) through (xi) is meant to include also any related co-product oligomeric species and polyfunctional thiirane compositions containing residual starting materials.

The first polyfunctional thiirane (a) is typically present in the polymerizable composition in an amount of at least 25 percent by weight, based on the total weight of monomers, for example in an amount of at least 35 percent by weight or at least 45 percent by weight, based on the total weight of the polymerizable composition. The first polyfunctional thiirane is also typically present in the polymerizable composition in an amount of less than or equal to 100 percent by weight, based on the total weight of monomers, for example in an amount less than 90 percent by weight or less than 80 percent by weight, based on the total weight of monomers. The amount of first polyfunctional thiirane (a) present in the polymerizable composition may range between any combination of these upper and lower values, inclusive of the recited values.

The polymerizable composition used in the method of the present invention also comprises at least one actinic radiation activated cationic polymerization initiator The actinic radiation activated cationic polymerization initiator is converted into an activated cationic polymerization initiator upon exposure to actinic radiation. In an embodiment of the present invention, the actinic radiation activated cationic polymerization initiator is selected from onium salts having an onium cation complex and a halide anion complex.

Onium salts that are useful as actinic radiation activated cationic polymerization initiators in the present invention include those represented by the following general formula IV,

(R⁴ₐR⁵_{b}R⁶_{c}R⁷_{d}Z)^{+M}(MYₙ)^{-m} IV

wherein (R⁴ₐR⁵_{b}R⁶_{c}R⁷_{d}Z)^{+m} is an onium cation complex of the onium salt; Z is selected from S, Se, Te, P, As, Sb, Bi, O, I, Br, Cl and N≡N; R⁴, R⁵, R⁶ and R⁷ are each selected independently from aliphatic groups, cycloaliphatic groups and aromatic groups; a, b, c and d are each independently an integer from 0 to 3, provided that the sum of a+b+c+d is equal to the valence of Z; (MYₙ)^{-m} is a halide anion complex of said onium salt; M is selected from B, P, As, Sb, Fe, Sn, Bi, Al, Ca, In, Ti, Zn, Sc, V, Cr, Mn and Co; Y is a halide (e.g., F, Cl, Br and I); n is equal to the valence of M; and m is the charge of the onium cation complex and the halide anion complex.

The onium cation complex of the onium salt represented by general formula IV is preferably selected from aromatic onium cation complexes, in which case R⁴, R⁵, R⁶ and R⁷ are each selected independently from aromatic groups. Preferred classes of aromatic onium cation complexes include, aromatic iodoniums and aromatic sulphoniums. In an embodiment of the present invention, the onium cation complex of onium salt initiator is selected from diphenyliodonium, 4-methoxydiphenyliodonium, bis(4-methylphenyl)iodonium, bis(4-tert-butylphenyl)iodonium, bis(dodecylphenyl)-iodonium, triphenylsulfonium and diphenyl-4-thiophenoxy-phenylsulfonium; and the halide anion complex of the onium salt initiator is selected from tetrafluoroborate (BF₄⁻), hexafluorophosphate (βF₆⁻), hexafluoroantimonate (SbF₆⁻), hexafluoroarsenate (AsF₆⁻) and hexacloroantimonate (SbCl₆⁻). Additional examples of halide anion complexes include, perchloric acid ion (CLO₄⁻), trifluoromethane sulfonate ion (CF₃SO₃⁻) , fluorosulfonate ion (FSO₃⁻), toluene sulfonate ion, trinitrobenzene sulfonate ion, and trinitrotoluene sulfonate ion.

The actinic radiation activated cationic polymerization initiator is typically present in the polymerizable composition in at least an initiating amount, i.e., an amount that is at least sufficient to initiate cationic polymerization of the polymerizable composition upon exposure to actinic radiation. In an embodiment of the present invention, the amount of actinic radiation activated cationic polymerization initiator should be adequate to produce a polymerizate which has a 15 second Barcol hardness of at least 1, preferably at least 4, e.g., from 4 to 35 (as determined in accordance with ASTM No. D 2583-95).

When the actinic radiation activated cationic polymerization initiator is selected from onium salts represented by general formula IV, the onium salt is typically present in an amount of from 0.001 percent by weight to 5 percent by weight, preferably from 0.01 percent by weight to 1 percent by weight, and more preferably from 0.05 percent by weight to 0.5 percent by weight, based on the total weight of polymerizable monomers present in the polymerizable composition.

The polymerizable composition of the method of the present invention may optionally further comprise a monofunctional thiirane having a single thiirane group. Examples of monofunctional thiiranes that may be present in the polymerizable composition include, but are not limited to, 1,2-propylene sulfide; 1-halo-2,3-propylene sulfide, e.g., 1-chloro-2,3-propylene sulfide; thioglycidyl esters of monocarboxylic acids, e.g., thioglycidyl acetic acid ester, thioglycidyl propionic acid ester and thioglycidyl benzoic acid ester; thioglycidyl ethers, e.g., methyl thioglycidyl ether, ethyl thioglycidyl ether, propyl thioglycidyl ether and butyl thioglycidyl ether; C₅-C₁₂ cycloalkylene sulfides, e.g., 6-thiabicyclo[3.1.0]hexane (cyclopentene sulfide), 7-thiabicyclo[4.1.0]heptane (cyclohexene sulfide), 8-thiabicyclo[5.1.0]octane (cycloheptene sulfide), 9-thiabicyclo[6.1.0]nonane (cyclooctene sulfide) and 11-thiabicyclo[8.1.0]undecane (cyclodecene sulfide); and mixtures of such monofunctional thiiranes.

The optional monofunctional thiirane may be present in the polymerizable composition in an amount of at least 1 percent by weight, based on the total weight of polymerizable monomers, for example in an amount of at least 10 percent by weight or at least 20 percent by weight, based on the total weight of polymerizable monomers The optional monofunctional thiirane may also be present in the polymerizable composition in an amount of less than 80 percent by weight, based on the total weight of polymerizable monomers, for example in an amount of less than 65 percent by weight or less than 50 percent by weight, based on the total weight of polymerizable monomers. The optional monofunctional thiirane may be present in the polymerizable composition in an amount ranging between any combination of these recited upper and lower values, inclusive of the recited values.

The polymerizable composition may further optionally comprise a second polyfunctional thiirane that has at least one fused ring epithio group, e.g., a thiabicyclo group. The second polyfunctional thiirane is different than the first polyfunctional thiirane (a). Examples of polyfunctional thiiranes from which the second polyfunctional thiirane may be selected include, but are not limited to, 7-thiabicyclo[4.1.0]hept-3-ylmethyl 7-thiabicyclo[4.1.0]heptane-3-carboxylic acid ester, 4-methyl-7-thiacibyclo[4.1.0]hept-3-ylmethyl 4-methyl-7-thiabicyclo[4.1.0]heptane-3-carboxylic acid ester, 3-(epithioethyl)-7-thiabicyclo[4.1.0]heptane, 2-(epithioethyl)-7-thiabicyclo[4.1.0]heptane, 3-(2,3-epithiopropyl)-7-thiabicyclo[4.1.0]heptane, 1-methyl-4-(2-methylthiiranyl)-7-thiabicyclo[4.1.0]heptane, 4,8-dithiatricyclo[5.1.0.0^{3,5}]octane, 3,8-dithiatricyclo[5.1.0.0^{2,4}]octane, 3-oxa-6,9-dithiatetracyclo[6.1.0.0^{2,4}.0^{5,7}]nonane, 3,6,9-trithiatetracyclo[6.1.0.0^{2,4}0^{5,7}]nonane, 5,10-dithiatricyclo[7.1.0.0^{4,6}]decane and mixtures thereof. A preferred second polyfunctional thiirane is 7-thiabicyclo[4.1.0]hept-3-ylmethyl 7-thiabicyclo[4.1.0]heptane-3-carboxylic acid ester.

The optional second polyfunctional thiirane may be present in the polymerizable composition in an amount of at least 1 percent by weight, based on the total weight of polymerizable monomers, for example in an amount of at least 10 percent by weight or at least 20 percent by weight, based on the total weight of polymerizable monomers Additionally, the optional second polyfunctional thiirane may be present in the polymerizable composition in an amount of less than 80 percent by weight, based on the total weight of polymerizable monomers, for example in an amount of less than 65 percent by weight or less than 50 percent by weight, based on the total weight of polymerizable monomers. The optional second polyfunctional thiirane may be present in the polymerizable composition in an amount ranging between any combination of these recited upper and lower values, inclusive of the recited values.

The polymerizable composition may yet further optionally comprise a polythiol having at least two thiol groups. Examples of polythiols that may be optionally present in the polymerizable composition include, but are not limited to, 2,2′-thiodiethanethiol, pentaerythritol tetrakis(3-mercaptopropionate), pentaerythritol tetrakis(2-mercaptoacetate), trimethylolpropane tris(3-mercaptopropionate), trimethylolpropane tris(2-mercaptoacetate), 4-mercaptomethyl-3,6-dithia-1,8-octanedithiol, 4-tert-butyl-1,2-benzenedithiol, 4,4′-thiodibenzenethiol, benzenedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), polythiols represented by general formula II, polythiols represented by general formula III, and mixtures thereof.

The polythiol monomer may optionally be present in the polymerizable composition in an amount of at least 1 percent by weight, based on the total weight of polymerizable monomers, for example in an amount of at least 10 percent by weight or at least 20 percent by weight, based on the total weight of polymerizable monomers. The polythiol may also be present in the polymerizable composition in an amount of less than 80 percent by weight, based on the total weight of polymerizable monomers, for example in an amount of less than 65 percent by weight or less than 50 percent by weight, based on the total weight of polymerizable monomers. The optional polythiol monomer may be present in the polymerizable composition in an amount ranging between any combination of these recited upper and lower values, inclusive of the recited values.

The cationically polymerizable composition may optionally further comprise one or more cyclic anhydride monomers. Preferably, the cyclic anhydride monomer is present in the polymerizable composition together with the polythiol monomer. As used herein and in the claims, the term “cyclic anhydride” refers to those materials in which the anhydride group is part of a cyclic ring. Examples of cyclic anhydrides that may be used in the present invention include, but are not limited to, phthalic anhydride, tetrahydrophthalic anhydride, hexahydrophthalic anhydride, hexahydromethylphthalic anhydride, maleic anhydride, citraconic anhydride, itaconic anhydride, chlorendic anhydride, methyl—S—norbornene-2,3-dicarboxylic anhydride, endo-bicyclo[2.2.2]oct-5-ene-2,3-dicarboxylic anhydride and pyromellitic dianhydride. The cyclic anhydride may contain halogen groups, e.g., chlorine and/or bromine groups, examples of which include halogenated derivatives of those cyclic anhydrides as recited previously herein. Preferred cyclic anhydrides include phthalic anhydride, methyl—S—norbornene-2,3-dicarboxylic anhydride and mixtures of phthalic anhydride and methyl-5-norbornene-2,3-dicarboxylic anhydride. If used, the cyclic anhydride is typically present in the composition in an amount of less than 20 percent by weight, based on the total weight of polymerizable monomers, more typically in an amount of less than 10 percent by weight, based on the total weight of polymerizable monomers.

In an embodiment of the present invention, the cationically polymerizable organic composition further comprises a cationically polymerizable monomer selected from (i) epoxide monomers having at least one epoxide group, (ii) ethylenically unsaturated cationically polymerizable monomers having at least one ethylenically unsaturated group, and (iii) mixtures of (i) and (ii). The optional epoxide monomer is free of thiirane groups and is different than the first and second polyfunctional thiiranes. Examples of epoxide monomers that may be present in the polymerizable composition include epoxides corresponding to those polyfunctional and monofunctional thiiranes as recited previously herein.

Ethylenically unsaturated cationically polymerizable monomers that may be present in the polymerizable composition include vinyl ethers, vinyl functional aromatic monomers and olefins. Vinyl ethers that may be present in the polymerizable composition include, for example, monofunctional vinyl ethers, such as linear or branched alkyl vinyl ethers and cycloalkyl vinyl ethers, and polyfunctional vinyl ethers, such as polyol vinyl ethers, e.g., ethylene glycol divinyl ether and trimethylolpropane trivinyl ether. Vinyl functional aromatic monomers that may be present in the polymerizable composition include, for example, styrene, divinyl benzene and trivinyl benzene Examples of olefins that may be presest in the polymerizable composition include, isobutylene and vinylcyclohexane. A preferred ethylenically unsaturated cationically polymerizable monomer is styrene.

The epoxide monomer and/or ethylenically unsaturated monomer when used are typically present in the polymerizable composition in a minor amount, e.g., in an amount totaling less than 50 percent by weight, based on the total weight of monomers present in the composition More typically, the epoxide monomer and/or ethylenically unsaturated monomer are optionally present in the polymerizable composition in amounts totaling less than 25 percent by weight, e.g., in an amounts totaling less than 10 percent by weight, based on the total weight of monomers present in the polymerizable composition.

Various conventional additives may be incorporated with the polymerizable organic composition of the present invention. Such additives may include light stabilizers, heat stabilizers, antioxidants, ultraviolet light absorbers, photosensitizers (e.g., benzophenone, benzoin isopropyl ether and thioxanthone), mold release agents, static (non-photochromic) dyes, pigments, and flexibilizing additives that are not cationically polymerizable (e.g., alkoxylated phenol benzoates, poly(alkylene glycol) dibenzoates, and poly(alkoxylated) bisphenols). Antiyellowing additives, e.g., 3-methyl-2-butenol, organo pyrocarbonates and triphenyl phosphite, may also be added to polymerizable organic compositions of the present invention to enhance resistance to yellowing. Such additives are typically present in the compositions of the present invention in amounts totaling less than 10 percent by weight, preferably less than 5 percent by weight, and more preferably less than 3 percent by weight, based on the total weight of the polymerizable composition.

The method of the present invention comprises exposing the cationically polymerizable organic composition to actinic radiation. The actinic radiation may be selected from visible light, ultraviolet (UV) light, electron beam, X-ray radiation, radio frequency radiation and combinations thereof. Preferably the actinic radiation is selected from visible light, UV light and combinations thereof. In an embodiment of the present invention, the wavelength of the actinic light is from 250 to 450 nanometers.

The actinic radiation source used for the polymerization may be selected from mercury lamps, xenon lamps, sodium lamps and alkali metal lamps. Preferably, the actinic radiation source is selected from those which emit ultraviolet light, e.g., mercury lamps, germicidal lamps and xenon lamps. Visible light, e.g., sunlight, may also be used. The exposure time may differ depending upon, e.g., the wavelength and intensity of the radiation source and the shape of the mold, and is typically determined empirically.

The first polyfunctional thiirane, any optional monomers, e.g., monofunctional thiiranes, second polyfunctional thiiranes, polythiols, cyclic anhydrides, epoxide monomers and ethylenically unsaturated monomers, and any additives are typically mixed together in a suitable container. The actinic radiation activated cationic polymerization initiator is then added to the monomer mixture and the polymerizable composition is charged to a mold, at least a portion of which is transparent to the actinic radiation, e.g., an ophthalmic lens mold fabricated from quartz glass. The filled mold is then exposed to actinic radiation, typically by passing or holding the filled mold under the actinic radiation source. Concurrent with or following exposure to actinic radiation, the filled mold may optionally be subjected to a thermal co- or post-cure, for example at a temperature of from 70° C. to 150° C., over a period of from 1 to 5 hours. After completion of the cationic polymerization, the polymerizate is typically removed from the mold, and may be further processed (e.g., cut, ground and/or polished) if desired.

Polymerizates obtained in accordance with the method of the present invention will be solid, and preferably transparent, e.g., suitable for optical or ophthalmic applications. In an embodiment, a polymerizate of the present invention has a refractive index of at least 1.6 (as determined in accordance with American Standard Test Method (ASTM) number D 542-95), an Abbe number of at least 27 (as determined using an instrument, such as a Bausch & Lomb ABBE-3L Refractometer), and a 15 second Barcol hardness of at least 1 (as determined in accordance with ASTM No. D 2583-95).

In an embodiment of the present invention, the refractive index will be at least 1.63, and in another embodiment at least 1.65. Further, in an embodiment of the present invention, the polymerizate will have an Abbe number of at least 29, and in another embodiment, at least 33 or 35.

Solid articles that may be prepared from polymerizable organic compositions of the present invention include, but are not limited to, optical lenses, such as plano and ophthalmic lenses, sun lenses, windows, automotive transparencies, e.g., windshields, sidelights and backlights, and aircraft transparencies, etc.

When used to prepare photochromic articles, e.g., lenses, the polymerizate should be transparent to that portion of the electromagnetic spectrum which activates the photochromic substance(s) incorporated in the matrix, i.e., that wavelength of ultraviolet (UV) light that produces the colored or open form of the photochromic substance and that portion of the visible spectrum that includes the absorption maximum wavelength of the photochromic substance in its UV activated form, i.e., the open form. Photochromic substances that may be utilized with the polymerizates of the present invention are organic photochromic compounds or substances containing same that may be incorporated, e.g., dissolved, dispersed or diffused into such polymerizates.

A first group of organic photochromic substances contemplated for use to form the photochromic articles of the present invention are those having an activated absorption maximum within the visible range of greater than 590 nanometers, e.g., between greater than 590 to 700 nanometers. These materials typically exhibit a blue, bluish-green, or bluish-purple color when exposed to ultraviolet light in an appropriate solvent or matrix. Examples of classes of such substances that are useful in the present invention include, but are not limited to, spiro(indoline)naphthoxazines and spiro(indoline)benzoxazines. These and other classes of such photochromic substances are described in the open literature. See for example, U.S. Pat. Nos.: 3,562,172; 3,578,602; 4,215,010; 4,342,668; 5,405,958; 4,637,698; 4,931,219; 4,816,584; 4,880,667; 4,818,096. Also see for example: Japanese Patent Publication 62/195383; and the text, Techniques in Chemistry, Volume III, “Photochromism,” Chapter 3, Glenn H. Brown, Editor, John Wiley and Sons, Inc., New York, 1971.

A second group of organic photochromic substances contemplated for use to form the photochromic articles of the present invention are those having at least one absorption maximum and preferably two absorption maxima, within the visible range of between 400 and less than 500 nanometers. These materials typically exhibit a yellow-orange color when exposed to ultraviolet light in an appropriate solvent or matrix. Such compounds include certain chromenes, i.e., benzopyrans and naphthopyrans. Many of such chromenes are described in the open literature, e.g., U.S. Pat. Nos. 3,567,605; 4,826,977; 5,066,818; 4,826,977; 5,066,818; 5,466,398; 5,384,077; 5,238,931; and 5,274,132.

A third group of organic photochromic substances contemplated for use to form the photochromic articles of the present invention are those having an absorption maximum within the visible range of between 400 to 500 nanometers and another absorption maximum within the visible range of between 500 to 700 nanometers. These materials typically exhibit color(s) ranging from yellow/brown to purple/gray when exposed to ultraviolet light in an appropriate solvent or matrix. Examples of these substances include certain benzopyran compounds, having substituents at the 2-position of the pyran ring and a substituted or unsubstituted heterocyclic ring, such as a benzothieno or benzofurano ring fused to the benzene portion of the benzopyran. Such materials are the subject of U.S. Patent No. 5,429,774.

Other photochromic substances contemplated are photochromic organo-metal dithizonates, i.e., (arylazo)-thioformic arylhydrazidates, e.g., mercury dithizonates, which are described in, for example, U.S. Pat. Nos. 3,361,706. Fulgides and fulgimides, e.g. the 3-furyl and 3-thienyl fulgides and fulgimides, are described in U.S. Pat. No. 4,931,220 at column 20, line 5 through column 21, line 38.

The disclosures relating to such photochromic substances in the aforedescribed patents are incorporated herein, in their entirety, by reference. The photochromic articles of the present invention may contain one photochromic substance or a mixture of photochromic substances, as desired. Mixtures of photochromic substances may be used to attain certain activated colors such as a near neutral gray or brown.

Each of the photochromic substances described herein may be used in amounts and in a ratio (when mixtures are used) such that a polymerizate to which the mixture of compounds is applied or in which they are incorporated exhibits a desired resultant color, e.g., a substantially neutral color such as shades of gray or brown when activated with unfiltered sunlight, i.e., as near a neutral color as possible given the colors of the activated photochromic substances. The relative amounts of the aforesaid photochromic substances used will vary and depend in part upon the relative intensities of the color of the activated species of such compounds, and the ultimate color desired.

The photochromic compounds or substances described herein may be applied to or incorporated into the polymerizate by various methods described in the art. Such methods include (a) dissolving or dispersing the substance within the polymerizate, e.g., imbibition of the photochromic substance into the polymerizate by immersion of the polymerizate in a hot solution of the photochromic substance or by thermal transfer; (b) providing the photochromic substance as a separate layer between adjacent layers of the polymerizate, e.g., as a part of a polymer film or polymer layer; and (c) applying the photochromic substance as part of a coating or polymer layer placed on the surface of the polymerizate. The term “imbibition” or “imbibe” is intended to mean and include permeation of the photochromic substance alone into the polymerizate, solvent assisted transfer absorption of the photochromic substance into a porous polymer, vapor phase transfer, and other such transfer mechanisms.

The amount of photochromic substance or composition containing same applied to or incorporated into the polymerizate is not critical provided that a sufficient amount is used to produce a photochromic effect discernible to the naked eye upon activation. Generally such an effective amount can be described as a photochromic amount. The particular amount used depends often upon the intensity of color desired upon irradiation thereof and upon the method used to incorporate or apply the photochromic substances. Typically, the more photochromic substance applied to or incorporated into the polymerizate, the greater is the color intensity of the resulting photochromic article. Generally, the amount of total photochromic substance incorporated into or applied to a photochromic optical polymerizate may range from 0.15 to 0.35 milligrams per square centimeter of surface to which the photochromic substance(s) is incorporated or applied.

It is also contemplated that photochromic substances may be added to the cationically polymerizable organic compositions of the method of the present invention prior to cationic polymerization. However, when this is done it is preferred that the photochromic substance(s) be resistant to potentially adverse interactions with the actinic radiation activated cationic polymerization initiator(s) and/or the thiirane groups of the monomers, the thiol groups of the optional polythiol monomer and the sulfide linkages that form within the polymerizate. These adverse interactions can result in deactivation of the photochromic substance(s), e.g., by trapping them in either an open or closed form. Photochromic substances can also include photochromic pigments and organic photochromic substances encapsulated in metal oxides, the latter of which are described in U.S. Pat. Nos. 4,166,043 and 4,367,170. Organic photochromic substances sufficiently encapsulated within a matrix of an organic polymerizate, as described in U.S. Pat. No. 4,931,220, may also be incorporated into the polymerizable organic compositions of the present invention prior to curing.

The present invention is more particularly described in the following example, which is intended to be illustrative only, since numerous modifications and variations therein will be apparent to those skilled in the art. Unless otherwise specified, all parts and all percentages are by weight.

### EXAMPLE

### Synthesis of 1,4-bis(epithiopropyloxy)butane

To a 3-neck round bottom flask equipped with a magnetic stirrer, thermometer, and additional funnel was charged 2 moles of thiourea, 2 moles of sulfuric acid and water to form a solution. The solution was then cooled to 5° C. To the cooled solution was added dropwise 1 mole of butanediol diglycidyl ether over a period of 1.5 hours with stirring. Following addition of the butanediol diglycidyl ether, the reaction mixture was stirred for 16 hours at ambient temperature. The solution was then washed with diethyl ether, the resulting ether phase was discarded, and the aqueous phase was retained. A solution of 2 moles of sodium carbonate in water was slowly added with stirring to the remaining aqueous solution. Upon completion of the sodium carbonate solution addition, the mixture was washed twice with toluene. The toluene phases were combined and washed with water until neutral pH was obtained. The remaining toluene solution was dried over magnesium sulfate, and solvent was evaporated to afford the title compound as a liquid.

### Polymerizate from cationic UV-cured monomer

The casting composition for the aforementioned polymerizate was as follows:

| Component | Composition |
|---|---|
| Divinylbenzene | 45 |
| 1,4-bis(epithiopropyloxy)butane | 40 |
| Bis(4-(epithiopropylthio)phenyl)sulfide | 15 |
| Darocure 4265 | 9 |

The components were charged and mixed with slight heating for several minutes. The mixture was then charged between two flat UV-transmissive glass molds with a cavity thickness of 3.2 mm. The filled mold was photopolymerized by passing the mold under a UV light source. The filled mold was passed under the UV light once, flipped over, and passed through a second time. This process was repeated three times. Demolding yielded a solid polymer sheet with a refractive index (D-line, 20° C.) of 1.6259, Abbe number of 29, and a 15 second Barcol 934 hardness of 18.

The present invention has been described with reference to specific details of particular embodiments thereof. It is not intended that such details be regarded as limitations upon the scope of the invention except insofar as and to the extent that they are included in the accompanying claims.

We claim:

1. A method of preparing a polymerizate comprising the step of polymerizing a cationically polymerizable organic composition by exposing to actinic radiation said polymerizable composition, said polymerizable composition comprising:
(a) at least one first polyfunctional thiirane having at least two functional groups represented by the following general formula, 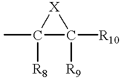
wherein X is selected from the group consisting of S and O, the number of functional groups wherein X is S constituting at least 50 percent of the total number of such functional groups present in said first polyfunctional thiirane, and R₈, R₉ and R₁₀ are each independently selected from the group consisting of hydrogen and C₁-C₁₀ alkyl; and
(b) at least one actinic radiation activated cationic polymerization initiator.

2. The method of claim l,wherein said first polyfunctional thiirane has backbone structure selected from the group consisting of linear or branched aliphatic backbone structure, cycloaliphatic backbone structure, heterocyclic backbone structure, aromatic backbone structure and combinations thereof, each backbone structure optionally having linkages selected from the group consisting of oxide linkages, sulfide linkages, disulfide linkages, sulfone linkages, ketone linkages, ester linkages, amino linkages, amide linkages, urethane linkages, thiourethane linkages, thiocarbamate linkages, dithiourethane linkages, urea linkages, thiourea linkages and combinations thereof.

3. The method of claim 2 wherein R₈, R₉ and R₁₀ are each hydrogen, and said first polyfunctional thiirane optionally has backbone linkages selected from the group consisting of oxide, sulfide and combinations thereof.

4. The method of claim 1 wherein said actinic radiation activated cationic polymerization initiator is an onium salt.

5. The method of claim 4 wherein said onium salt is represented by the following general formula,
(R⁴ₐR⁵_{b}R⁶_{c}R⁷_{d}Z)^{+m}(MYₙ)^{-m}
wherein (R⁴ₐR⁵_{b}R⁶_{c}R⁷_{d}Z)^{+m} is an onium cation complex of said onium salt; Z is selected from the group consisting of S, Se, Te, P, As, Sb, Bi, O, I, Br, Cl and N≡N; R⁴, R⁵, R⁶ and R⁷ are each independently selected from the group consisting of aliphatic groups, cycloaliphatic groups and aromatic groups; a, b, c and d are each independently an integer from 0 to 3, provided that the sum of a+b+c+d is equal to the valence of Z; (MYₙ)^{-m} is a halide anion complex of said onium salt; M is selected from the group consisting of B, P, As, Sb, Fe, Sn, Bi, Al, Ca, In, Ti, Zn, Sc, V, Cr, Mn and Co; Y is a halide; n is equal to the valence of M; and m is the charge of the onium cation complex and the halide anion complex.

6. The method of claim 5 wherein said onium cation complex is selected from the group consisting of diphenyliodonium, 4-methoxydiphenyliodonium, bis(4-methylphenyl)iodonium, bis(4-tert-butylphenyl)iodonium, bis(dodecylphenyl)-iodonium, triphenylsulfonium and diphenyl-4-thiophenoxy-phenylsulfonium; and said halide anion complex is selected from the group consisting of tetrafluoroborate, hexafluorophosphate, hexafluoroantimonate, hexafluoroarsenate and hexacloroantimonate.

7. The method of claim 1 wherein said cationically polymerizable organic composition further comprises a monofunctional thiirane having a single thiirane group.

8. The method of claim 7 wherein said monofunctional thiirane is selected from the group consisting of ethylene sulfide, 1,2-propylene sulfide, 1-halo-2,3-propylene sulfide, thioglycidyl esters of monocarboxylic acids, thioglycidyl ethers, C₅-C₁₂ cycloalkylene sulfides and mixtures thereof.

9. The method of claim 1 wherein said cationically polymerizable organic composition further comprises a second polyfunctional thiirane having at least one fused ring epithio group, said second polyfunctional thiirane being different than said first polyfunctional thiirane (a).

10. The method of claim 9 wherein said second polyfunctional thiirane is selected from the group consisting of 7-thiabicyclo[4.1.0]hept-3-ylmethyl 7-thiabicyclo[4.1.0]heptane-3-carboxylic acid ester, 4-methyl-7-thiacibyclo[4.1.0]hept-3-ylmethyl 4-methyl-7-thiabicyclo[4.1.0]heptane-3-carboxylic acid ester, 3-(epithioethyl)-7-thiabicyclo[4.1.0]heptane, 2-(epithioethyl)-7-thiabicyclo[4.1.0]heptane, 3-(2,3-epithiopropyl)-7-thiabicyclo[4.1.0]heptane, 1-methyl-4-(2-methylthiiranyl)-7-thiabicyclo[4.1.0]heptane, 4,8-dithiatricyclo[5.1.0.0^{3,5}]octane, 3,8-dithiatricyclo[5.1.0.0^{2,4}]octane, 3-oxa-6,9-dithiatetracyclo[6.1.0.0^{2,4}.0^{5,7}]nonane, 3,6,9-trithiatetracyclo[6.1.0.0^{2,4}.0^{5,7}]nonane, 5,10-dithiatricyclo[7.1.0.0^{4,6}]decane and mixtures thereof.

11. The method of claim 1 wherein said cationically polymerizable organic composition further comprises a polythiol having at least two thiol groups.

12. The method of claim 11 wherein said polythiol is selected from the group consisting of 2,2′-thiodiethanethiol, pentaerythritol tetrakis(3-mercaptopropionate), pentaerythritol tetrakis(2-mercaptoacetate), trimethylolpropane tris(3-mercaptopropionate), trimethylolpropane tris(2-mercaptoacetate), 4-mercaptomethyl-3,6-dithia-1,8-octanedithiol, 4-tert-butyl-1,2-benzenedithiol, 4,4′-thiodibenzenethiol, benzenedithiol, ethylene glycol di(2-mercaptoacetate), ethylene glycol di(3-mercaptopropionate), poly(ethylene glycol) di(2-mercaptoacetate), poly(ethylene glycol) di(3-mercaptopropionate), a polythiol monomer represented by the following general formula, 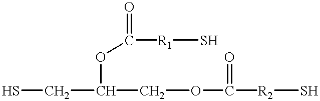
a polythiol monomer represented by the following general formula, 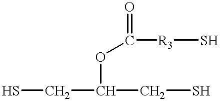
wherein R₁, R₂ and R₃ are each selected independently for each general formula from the group consisting of straight or branched chain alkylene, cyclic alkylene, phenylene and C₁-C₉ alkyl substituted phenylene, and mixtures of such polythiol monomers.

13. The method of claim 11 wherein said cationically polymerizable organic composition further comprises a cyclic anhydride monomer.

14. The method of claim 13 wherein said cyclic anhydride monomer is selected from the group consisting of phthalic anhydride, tetrahydrophthalic anhydride, hexahydrophthalic anhydride, hexahydromethylphthalic anhydride, maleic anhydride, citraconic anhydride, itaconic anhydride, chlorendic anhydride, methyl-5-norbornene-2,3-dicarboxylic anhydride, endo-bicyclo[2.2.2]oct-5-ene-2,3-dicarboxylic anhydride, pyromellitic dianhydride and mixtures thereof.

15. The method of claim 1 wherein said cationically polymerizable organic composition further comprises a cationically polymerizable monomer selected from the group consisting of (i) epoxide monomers having at least one epoxide group, (ii) ethylenically unsaturated cationically polymerizable monomers having at least one ethylenically unsaturated group, and (iii) mixtures of (i) and (ii).

16. The method of claim 1 wherein said cationically polymerizable organic composition further comprises:
(c) at least one second polyfunctional thiirane having at least one fused ring epithio group, said second polyfunctional thiirane being different than said first polyfunctional thiirane (a); and
(d) at least one polythiol having at least two thiol groups.

17. The method of claim 16 wherein said cationically polymerizable organic composition further comprises a monofunctional thiirane having a single thiirane group.

18. The method of claim 17 wherein said cationically polymerizable organic composition further comprises a cationically polymerizable monomer selected from the group consisting of (i) epoxide monomers having at least one epoxide group, (ii) ethylenically unsaturated cationically polymerizable monomers having at least one ethylenically unsaturated group, and (iii) mixtures of (i) and (ii).

19. The method of claim 1 wherein R₈, R₉ and R₁₀ are each hydrogen, and said first polyfunctional thiirane is selected from polyfunctional thiiranes represented by the following general formulas: 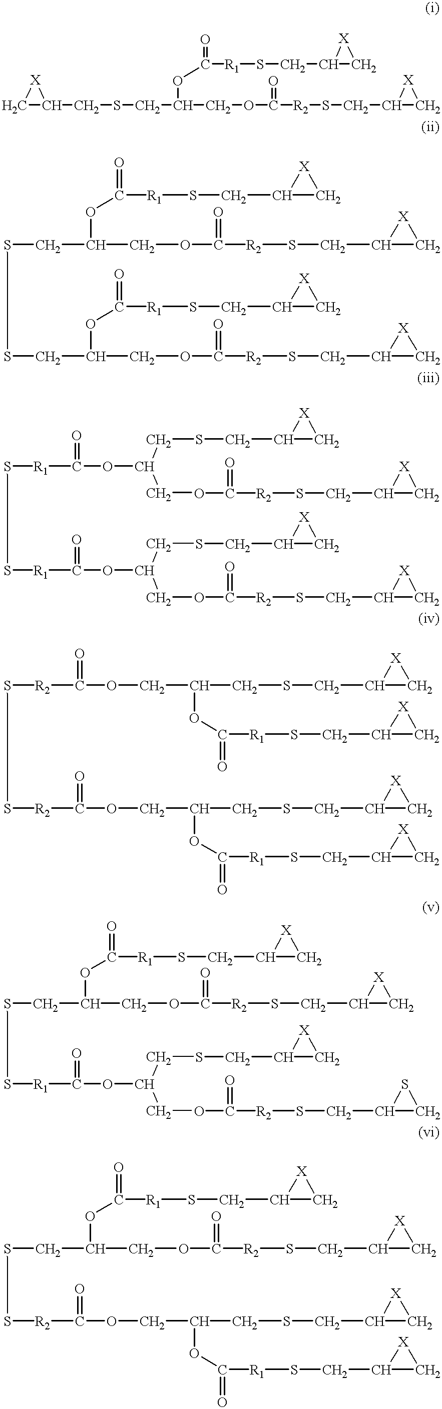
and mixtures of at least two of (i), (ii), (iii), (iv), (v), (vi), (vii), (viii), (ix), (x) and (xi);
wherein X is selected from the group consisting of S and O, the number of functional groups wherein X is S constituting at least 50 percent of the total number of such functional groups present in said polyfunctional thiirane; and R₁, R₂ and R₃ are each selected independently for each general formula from the group consisting of linear or branched chain alkylene, cyclic alkylene, phenylene and C₁-C₉ alkyl substituted phenylene.

20. The method of claim 19 wherein R₁, R₂ and R₃ are each selected independently for each structure from the group consisting of linear or branched chain alkylene.

21. The method of claim 20 wherein R₁, R₂ and R₃ are each selected independently from the group consisting of methylene and ethylene.

22. The polymerizate of claim 1.

23. The polymerizate of claim 16.

24. The polymerizate of claim 18.

25. A photochromic article comprising:
(a) the polymerizate of claim 1; and
(b) a photochromic amount of an organic photochromic substance.

26. The photochromic article of claim 25 wherein the organic photochromic substance is selected from the group consisting of spiro(indoline)naphthoxazines, spiro(indoline)benzoxazines, benzopyrans, naphthopyrans, chromenes, organo-metal dithizonates, fulgides and fulgimides and mixtures of such organic photochromic substances.

27. The method of claim 1 wherein said polymerizate has a refractive index of at least 1.6 and an Abbe number of at least 27.

28. The method of claim 1 wherein said polymerizate has a refractive index of at least 1.6 and an Abbe number of at least 29.

29. The method of claim 27 wherein said polymerizate has a 15 second Barcol hardness of at least 1.

30. The method of claim 28 wherein said polymerizate has a 15 second Barcol hardness of at least 1.
